(19) United States
(12) Patent Application Publication
(10) Pub. No.: US 2010/0257110 A1
(43) Pub. Date: Oct. 7, 2010

(54) PROCESS FOR OBTAINING GREENHOUSE GAS EMISSION CREDITS

(75) Inventor: Vincent VAN DEN BOSSCHE, Clermont-Ferrand (FR)

Correspondence Address: BUCHANAN, INGERSOLL & ROONEY PC, POST OFFICE BOX 1404, ALEXANDRIA, VA, 22313-1404, US

(73) Assignee: Michelin Recherche et Technique S.A., CH-1763 GRANGES-PACCOT (CH)

(21) Appl. No.: 12/813,690

(22) Filed: Jun. 11, 2010

Related U.S. Application Data
(63) Continuation of application No. 11/333,366, filed on Jan. 18, 2006, now abandoned.

(30) Foreign Application Priority Data
Jul. 18, 2003 (FR) 03/08840
Feb. 24, 2005 (EP) PCT/EP2004/007724

(51) Int. Cl. G06Q 99/00; G06Q 50/00

(52) U.S. Cl. 705/317

(57) ABSTRACT

The invention concerns a process for obtaining credits for the emission of greenhouse gases produced by the circulation of a vehicle powered by a heat engine, in which:
in a first stage, means are identified that can contribute towards a variation of the greenhouse gas emissions produced due to the circulation of the vehicle,
in a second stage, the relation establishing that variation is determined,
in a third stage, a certifying body guarantees the variation of the greenhouse gas emissions produced due to the circulation of the vehicle and related to the said means,
in a fourth stage, an organization determines the attributable greenhouse gas emission credit.

The present invention concerns a process for obtaining greenhouse gas emission credits, the gases being produced by the circulation of vehicles powered by a heat engine.

Since the beginning of the industrial age the production of consumer goods, whether material or not, has resulted in air pollution, in particular by the production of greenhouse gases such as carbon dioxide.

Other sources that produce such gases are means of transport powered by heat engines.

For several years organizations have stressed these phenomena and drawn the attention of the public to the risks for the environment and living species stemming from the production of greenhouse gases.

More recently, most governments that heed these messages have made progress in this direction and wish to take the preservation of the environment into account.

The Framework Convention of the United Nations and the KYOTO Protocol on climate change are examples of this progress and of awareness of the need to reduce emissions of greenhouse gases.

The Framework Convention of the United Nations on climate change, signed in 1992, aspired to stabilize the concentrations of greenhouse gases in the atmosphere at a level which would not endanger the climate system.

The Kyoto Protocol, which goes back to 1997 but has not yet been ratified, defines commitments on quantified targets for the reduction of greenhouse gas emissions in countries that ratify it.

The Kyoto Protocol also provides for “flexible mechanisms” which allow the acquisition of greenhouse gas emission credits by countries and/or enterprises, and the exchange of these credits or emission rights.

The European directive amending Directive 96/61/EC aims to establish a system for the exchange of greenhouse gas emission quotas in the European Union in relation to emissions from fixed installations such as boiler houses.

In the United States a private assets exchange has been created in Chicago whose purpose is to deal in the trading of greenhouse gas emission credits.

At present, governments aim essentially to reduce greenhouse gas emissions by the action of industries on fixed sources, and thus essentially by action on the emissions produced by production sites.

In studies concerning in particular the role of an enterprise connected with the movement of vehicles and the impact this can have on improving environment-related conditions, the inventors set out to provide a way of reducing greenhouse gas emissions produced by the said vehicles.

Although not limited to such vehicles, the invention will be described with more particular reference to the vehicles of a road haulage company that has several tens of vehicles.

The study carried out in the context of such a company is based on the facts that a single such entity, when all its vehicles are working, can constitute a substantial source of greenhouse gas production and besides, that the budget it devotes to fuel and tires is proportionally large.

Thus, one purpose of the invention is to determine a process that makes it possible to define how the equipment conditions of such vehicles can be improved with a view, on the one hand, to contributing towards the reduction of greenhouse gas emissions during their circulation and, on the other hand, the reduction of running costs.

According to the invention this objective has been achieved by a process for obtaining greenhouse gas emission credits for gases produced by vehicle powered by a heat engine during its circulation, in accordance with which:
in a first stage, means are identified that can contribute to a variation of the production of greenhouse gases during the circulation of the vehicle,
in a second stage, the relation establishing that variation is determined,
in a third stage, a certifying body guarantees the variation of the production of greenhouse gases during the circulation of the vehicle and related to the said means,
in a fourth stage, an organization determines the attributable greenhouse gas emission credit.

The invention so defined effectively enables the user of the vehicles to derive profit from his contribution to the reduction of greenhouse gas emissions by the certification of the said reduction of greenhouse gas emissions, and so to obtain credits for greenhouse gas emissions. In other words, according to the invention the user can improve the performance of his vehicles, in particular in terms of environmental impact, with lower equipment costs.

According to a preferred embodiment of the invention, in particular to simplify its implementation and restrict the number of people involved and hence the operating costs, the organization itself issues the certification.

According to another embodiment of the invention, the organization is an asset exchange. In this second embodiment of the invention, the additional party involved is the person who subsequently manages the exchanges of greenhouse gas emission credits, and this does not therefore lead to an increase of costs.

According to a third embodiment, and in particular when this is required by law, the said organization is one designated by a State or group of States.

In a variant embodiment of the invention, the means that contribute towards a variation of the greenhouse gas emissions produced due to the circulation of the vehicle is a tire.

According to this variant embodiment of the invention, the relation establishing the variation of the production of greenhouse gas emissions due to the vehicle's circulation is advantageously defined by the rolling resistance of the tire compared with that of a reference tire.

The reference tire is preferably defined in advance by the certifying body.

The relation establishing the variation of the greenhouse gas emission production can also be defined by a relation linking the rolling resistance to other parameters such as the number of kilometers covered during a given time, the vehicle's load, the type of road surface, the driver's driving habits, etc.

Preferably, the vehicles are of the “heavy vehicle” (or “heavy truck”) type and all their tires are tires for which the variation of greenhouse gas emission production due to the vehicle's circulation and relating to those tires, is certified.

The invention also proposes to use a measurement of the rolling resistance of a tire, compared with that of a reference tire, to determine the variation of greenhouse gas emissions produced due to the circulation of the vehicle powered by a heat engine.

Preferably, the invention proposes the use of the measurement of a tire's rolling resistance, compared with that of a reference tire, to determine a greenhouse gas emission credit produced by the circulation of the vehicle powered by a heat engine.

The invention also envisages the use of a tire on a vehicle of the “heavy” type, measurement of the rolling resistance of which, compared with that of a reference tire, establishes a variation of greenhouse gas emissions produced due to the said vehicle's circulation and secures a greenhouse gas emission credit for the vehicle's circulation.

Finally, the invention proposes a vehicle powered by a heat engine and fitted with tires whose rolling resistances are measured, these measurements, compared with those of reference tires, establishing a variation of the greenhouse gas emissions produced due to the use of the vehicle for driving, and whose driving determines a greenhouse gas emission credit.

Other advantageous details and characteristics of the invention emerge below from the description of the invention's implementation with a type of vehicle.

This example of the invention's implementation concerns the fitting of a tire model to vehicles of the heavy type. More precisely, the invention is implemented in the context of a road haulage company having a fleet of vehicles, i.e. a group comprising several tens of vehicles.

In a first stage the implementation of the invention can consist in getting a qualified or certifying body to establish the variation of greenhouse gas emissions produced when the vehicles are driving with the tire model concerned, compared to a reference tire model and more precisely a tire model customarily used for this type of application.

Of course, the said certifying body must have been identified in advance and must be independent of all the parties concerned.

In a second stage, the said organization can determine the greenhouse gas emission credit attributable for a vehicle fitted with that tire model.

The user then receives a greenhouse gas emission credit because of his contribution to reducing environmental pollution when he uses tires whose rolling resistance is lower than that of other tires used as reference tires.

In the case considered, that of a fleet of vehicles, the gains so derived can constitute a substantial fraction in relation to the tire-related budget of such a company.

Moreover, those greenhouse gas emission credits are attributed annually whereas the tires are not necessarily changed every year. The gains obtained in the form of greenhouse gas emission credits can therefore accumulate several times over in several successive years, independently of the expenditure for purchasing years.

This point is the more advantageous, the longer is the life of the tires and because the options of re-grooving and/or retreading and also repair, which allow the life of the tire's carcass to be extended, are less costly than the purchase of a new tire.

The invention should not be regarded as limited to the case discussed above, but can also extend to means other than tires, and the user can of course accumulate greenhouse gas emission credits obtained by each of those means.

The invention also extends to vehicles other than those of the heavy type and to vehicles not necessarily owned by companies but also by individuals.

1. Process for using improved tire rolling resistance of a subject vehicle tire to obtain credits for a contribution in greenhouse gas emission variation produced by heat engine powered vehicle circulation, comprising:
A. determining the rolling resistance of the subject vehicle tire;
B. determining the rolling resistance of a reference vehicle tire;
C. calculating a reduction in the rolling resistance of the subject vehicle tire compared to that of the reference vehicle tire;
D. operating the vehicle with each tire thereon being the subject vehicle tire and measuring the greenhouse gas emissions produced during such operation;
E. operating the vehicle with each tire thereon being the reference vehicle tire and measuring the greenhouse gas emissions produced during such operation;
F. determining that a variation in greenhouse gas emission is produced by the reduction in rolling resistance during step D as compared to step E;
G. certifying the variation determined in step F; and
H. determining a greenhouse gas emission credit attributable to the certified variation.
